(19) United States
(12) Patent Application Publication
(10) Pub. No.: US 2002/0162433 A1
(43) Pub. Date: Nov. 7, 2002

(54) Method and apparatus for separating fleurettes from long-stemmed vegetables having flowery heads

(75) Inventor: Edward M. Centeno, Royal Oaks, CA (US)

Correspondence Address: Robert Charles Hill, 235 Montgomery Street #821, San Francisco, CA, 94104, US

(73) Assignee: Mann Packing Co., Inc.

(21) Appl. No.: 09/848,735

(22) Filed: May 3, 2001

(51) Int. Cl. B26D 1/00

(52) U.S. Cl. 83/13; 83/932

(57) ABSTRACT

A cutting device for separating fleurettes from the stalk of a long-stemmed vegetable having a flowery head. The cutting device has at least three blades positioned symmetrically around a perpendicular center axis and a moving means for moving each blade downward in a linear motion toward that center axis. Each blade has two flat surfaces joined at a linear backbone, and each of those flat surfaces has a cutting edge on its bottom. Each backbone forms an angle with the center axis of from 25 to 45 degrees. The moving means moves the blades downward in linear motions toward the center axis in the same angles with the center axis as formed by their respective blade backbones.

The present invention relates to separation of fleurettes from long-stemmed vegetables with flowery heads such as broccoli and cauliflower.

### BACKGROUND OF THE INVENTION

A variety of vegetables and other produce items are generally known to require cutting or trimming prior to packaging and/or shipment to consumer markets. Such produce items can include broccoli and cauliflower and the like, which generally grow in the form of stalked heads having an overall size frequently exceeding the size of a standard consumer unit. Alternately, or in addition, the stalked head has a size and shape that is not conducive to convenient space-efficient packaging. Accordingly, produce items of this type are commonly trimmed to a required size and shape promptly after picking.

In the past, produce items such as broccoli and cauliflower have been cut or trimmed by the use of manual labor to insure relative uniformity in the resultant cut products notwithstanding natural growth variations in the uncut product. The use of manual labor, however, adds significantly to the overall cost of the product to the ultimate consumer.

Many different automated or semi-automated machines have been proposed for use in cutting and trimming such vegetables.

U.S. Pat. No. 6,036,989 “Vegetable core removal apparatus” to Anthony George Ellis teaches using a pair of pivotably-mounted cutter lobes having oblique cutting edges which are movable in beak-like manner.

U.S. Pat. No. 5,470,602 “Broccoli head trimming apparatus and method” to Christopher R. Cecil teaches using special U-shaped guillotine blades.

U.S. Pat. No. 5,277,107 “Trimmer for vegetables including broccoli” to Antonio Turatti teaches using cutters which trim rotating vegetables.

U.S. Pat. No. 5,074,203 “Coring apparatus” and U.S. Pat. No. 5,009,909 “Coring method,” both to Thomas W. Hirtle et al., teach holding the vegetable in a fixed position by an impaling knife or pin, while one or more rotating coring knives are lowered into engagement with the vegetable by a pivoting arm mechanism. The pivoting arm mechanism causes each rotating knife to trace out a generally helical path as it cores the vegetable.

U.S. Pat. No. 4,773,324 “Broccoli trimming machine” to John V. Wylie et al. teaches a bowl-shaped cutter at the scalping station moved into cutting relation with the broccoli heads to scalp each head along a curved, substantially semi-spherical line to approximate the curved contour of the top of a broccoli head to be cut.

U.S. Pat. No. 4,658,714 “Apparatus for cutting broccoli and other long stemmed vegetables” to Jack R. McIlvain et al. teaches firmly gripping the vegetable by the stem and then cutting longitudinally through the stem and partially through the head.

U.S. Pat. No. 4,241,096 “Method for coring cauliflower heads” to Richard A. Shaw teaches a horizontally adjustable hold-down ring for engaging a head to keep it from moving out of its bowl as the first cutter rotates and removes the culls from the head by a coring effect. After its culls have been removed, the head is engaged and cut by a second rotary cutter that disintegrates the head and separates it into curds.

U.S. Pat. Nos. 6,036,989; 5,470,602; 5,277,107; 5,074,203; 5,009,909; 4,773,324; 4,658,714; and 4,241,096, identified above, are hereby incorporated by reference for all purposes.

### SUMMARY OF THE INVENTION

The present invention provides a method and apparatus for separation of fleurettes from long-stemmed vegetables with flowery heads, such as broccoli and cauliflower, in such a way as to reduce the amount of sellable weight lost in separation, while making a product that is more desirable to customers.

This invention is based upon the discovery that the fleurettes will have longer stems, and less fleurette stem will remain on the stalk, if the vegetable is placed head-down on a surface and the fleurettes are separated from the stalk by sharp angular blades at an angle of from 45 to 65 degrees from that surface (25 to 45 degrees from the perpendicular).

An advantage of the present invention is that less of the fleurette stems are left on the stalk, thereby more fleurette can be sold.

An ancillary advantage of the present invention is that many customers prefer fleurettes with longer stems because it is easier to hold the stem while dipping the flowery head into a sauce or dip.

The cutting device used in the present invention has at least three blades positioned symmetrically around a perpendicular center axis and a moving means for moving each blade downward in a linear motion toward that center axis. Each blade has two flat surfaces joined at a linear backbone, and each of those flat surfaces has a cutting edge on its bottom. Each backbone forms an angle with the center axis of from 25 to 45 degrees. The moving means moves the blades downward in linear motions toward the center axis in the same angles with the center axis as formed by their respective blade backbones. Preferably, the moving means is a cylindrical piston means, preferably comprising separate cylindrical pistons for each blade.

Preferably, each backbone forms an angle with the center axis of 30 to 40 degrees, more preferably about 35 degrees.

A surprising feature of one embodiment is that the action of the blades serves not only to sever the fleurettes from the stalk of the long-stemmed vegetable, but also serves to sharpen each other. In that embodiment, the cutting device has four blades, and the two flat surfaces of each blade forms a perpendicular angle. Two of the blades have inside cutting surfaces and two have outside cutting surfaces. The four blades are arranged symmetrically around the center axis so that the two blades having inside cutting surfaces are opposite each other and the two blades having outside cutting surfaces are opposite each other. The blades with the outside cutting surfaces are offset closer to each other than the blades with inside cutting surfaces. When the four blades move toward the center axis, each outside cutting surface contacts an inside cutting surface to self-sharpen both surfaces.

The cutting device can be used in conjunction with a conveyor means. That conveyor means includes vegetable supports for indexed advancing of vegetables, a loading station and a cutting station. The conveyor means advances the vegetables from the loading station to the cutting station so the center axis of the cutting device passes through the vegetables.

The cutting device can be used in a method of separating fleurettes from the stalk of a long-stemmed vegetable having a flowery head, wherein the vegetable is positioned on a surface under the cutting device and the perpendicular center axis of the cutting device passes through the vegetable. The stalk should be substantially upright relative to the surface upon which the vegetable rests. Each blade of the cutting device is moved downward toward the vegetable in a linear motion to sever the fleurettes from the vegetable.

Preferably, the vegetable is positioned under the cutting device by moving the vegetable along a conveyor means.

One of the surprising features of this invention is that the blades can be set to intersect the vegetable at a set height off the surface (about 1 ⅜ to 1 ⅝ inches for broccoli) and that setting will be good for a wide variety of sizes for that vegetable. In other words, a substantially upright stalk of broccoli is cut at a set height of about 1 ⅜ to 1 ⅝ inches from the top of the flowery head, preferably about 1.5 inches.

### BRIEF DESCRIPTION OF THE DRAWINGS

In order to assist the understanding of this invention, reference will now be made to the appended drawings. The drawings are exemplary only, and should not be construed as limiting the invention.

FIG. 1 is a side sectional view of the cutting device with the blades extended, cutting into the long-stemmed vegetable.

FIG. 2 is a side sectional view of the cutting device with the blades retracted from a long-stemmed vegetable.

FIG. 3 is a three-dimensional view of four blades in the retracted position.

FIG. 4 is a three-dimensional view of four blades in the halfway position.

FIG. 5 is a three-dimensional view of four blades in the cutting position.

FIG. 6 is a line drawing representing a broccoli stalk cut by the prior art rounded blade (A) and a broccoli stalk cut by the present invention (B).

FIG. 7 is a view of a blade having inside cutting surfaces.

### DETAILED DESCRIPTION OF THE INVENTION

In its broadest aspect, the present invention involves positioning the vegetable on a surface so that the stalk is substantially upright, then positioning a cutting device over the vegetable, and moving the blades of the cutting device toward the vegetable in a linear motion to sever the fleurettes from the stalk at an angle of from 45 to 65 degrees from that surface (25 to 45 degrees from the perpendicular). For broccoli this severing of the fleurettes from the stalk can happen at a set height off the surface of about 1 ⅜ to 1 ⅝ inches.

### DEFINITIONS

As used herein the following terms have the following meanings unless expressly stated to the contrary:

The term “fleurette” refers to a small flower on a long-stemmed vegetable having a flowery head. Alternative spellings found in the literature for “fleurette” are “flowerete,” “flowerette,” and “floret.”

The term “stalk” refers to the main axis of a plant.

The term “stem” refers to the main axis of a fleurette connected to a stalk on that plant.

The term “long-stemmed vegetable” refers to a vegetable having a long stalk.

The term “cutting edge” means the sharp edge of the cutting surface that first contacts the vegetable and does the initial cutting.

The term “blade having inside cutting surfaces” is a blade wherein the cutting edges on the bottom of the two flat surfaces are on the side facing the center axis.

The term “blade having outside cutting surfaces” is a blade wherein the cutting edges on the bottom of the two flat surfaces are on the side away from the center axis.

### THE CUTTING DEVICE

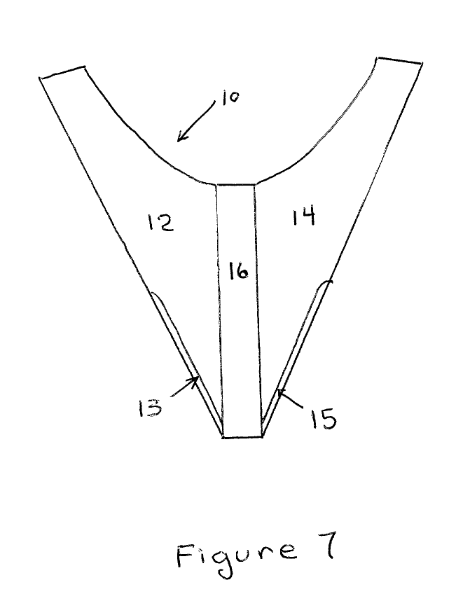

The cutting device used in the present invention for separating fleurettes from the stalk of a long-stemmed vegetable having a flowery head has at least three blades, preferably four blades, positioned symmetrically around a center perpendicular axis, and it has a moving means for moving each blade downward in a linear motion toward that center axis. As shown in FIG. 7, each blade, generally indicated 10, has two flat surfaces 12 and 14 joined at a linear backbone 16, each flat surface 12 and 14 has a cutting edge on the bottom of the surface, and each backbone forms an angle with the center axis of from 25 to 45 degrees. Preferably, that angle is from 30 to 40 degrees, more preferably about 35 degrees.

FIG. 7 shows a blade having inside cutting surfaces because the cutting edges 13 and 15 on the bottom of the two flat surfaces, 12 and 14 respectively, are on the side of the blade 10 facing the center axis. Likewise, a blade having outside cutting surfaces would have the cutting edges on the bottom of the two flat surfaces on the side away from the center axis and would be shown by dotted lines in FIG. 7.

If four blades are used, the two flat surfaces of each blade preferably form a perpendicular angle.

The moving means moves each blade downward in the same angle with the center axis as formed by the backbone of that blade. Preferably, the moving means is a cylindrical piston means, preferably comprising separate cylindrical pistons for each blade. In an alternative embodiment, there is one cylindrical piston that moves all the blades.

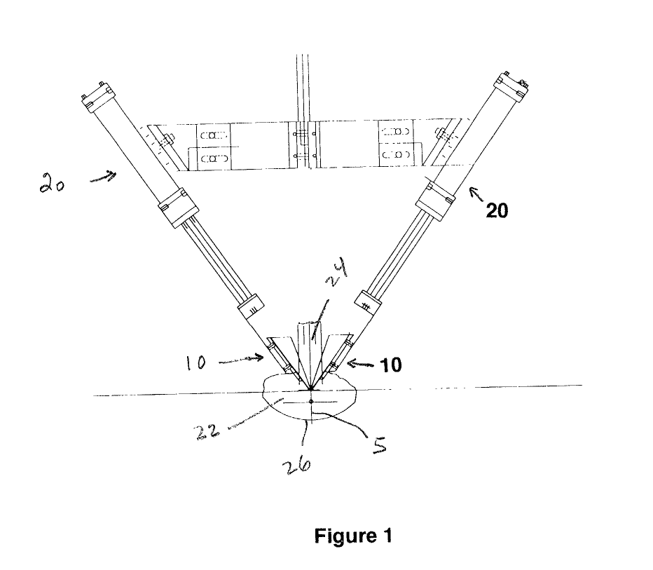

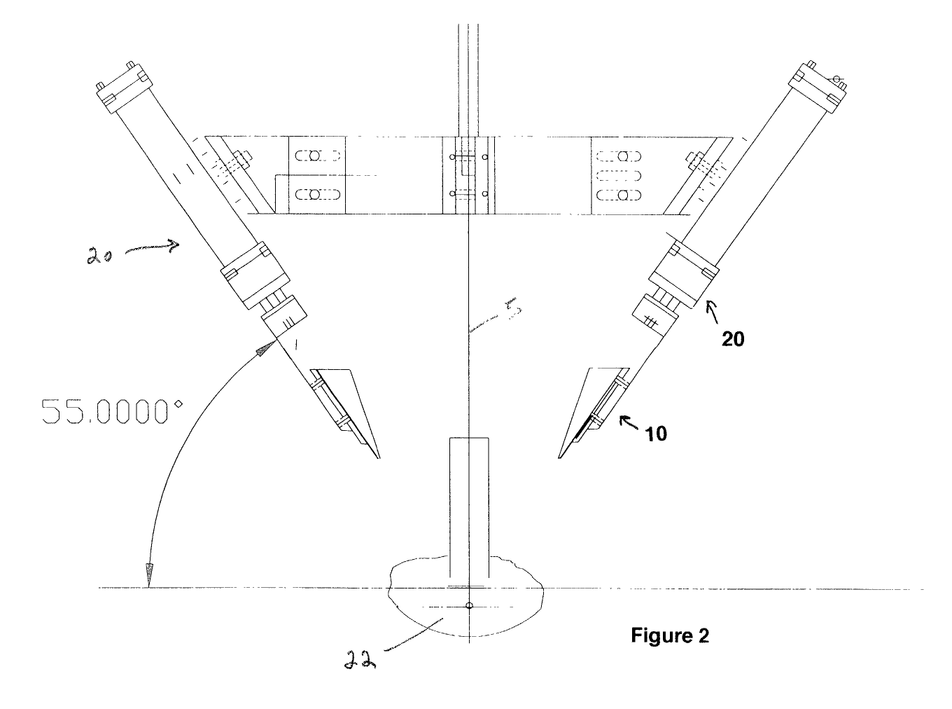

Referring to FIGS. 1 and 2, FIG. 2 shows a side sectional view of one embodiment of the cutting device, with the blades 10 retracted from a flowery head 22 of broccoli. FIG. 1 shows a side sectional view of the cutting device in the same embodiment with the blades 10 extended, cutting into the stalk 24 of broccoli. The blades are moved to and from the perpendicular center axis 5 by use of cylindrical pistons, generally indicated 20. Notice that the blades travel in a direction that is at angle of 55 degrees with the horizontal, and 35 degrees with the perpendicular center axis 5.

A surprising feature of this invention is that, in one embodiment, the action of the blades serves not only to sever the fleurettes from the stalk of the long-stemmed vegetable, but the action of the blades also serves to sharpen those blades. In that embodiment, four blades are used. Two of the blades have inside cutting surfaces and two have outside cutting surfaces. The four blades are arranged symmetrically around the center axis so that the two blades having inside cutting surfaces are opposite each other and the two blades having outside cutting surfaces are opposite each other. The blades with the outside cutting surfaces are offset closer to each other, so that when the four blades move toward the center axis, each outside cutting surface contacts an inside cutting surface to self-sharpen the surfaces.

This self-sharpening feature is important because if the blades are not sharp the there will be an uneven cut on the fleurette stem, which causes the cut part of the stem to turn brown in a couple of days, making the fleurette unmarketable.

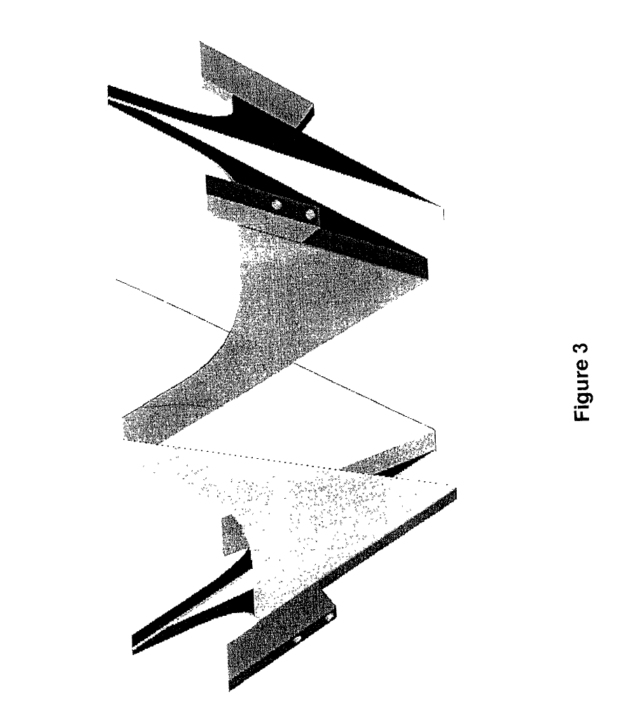

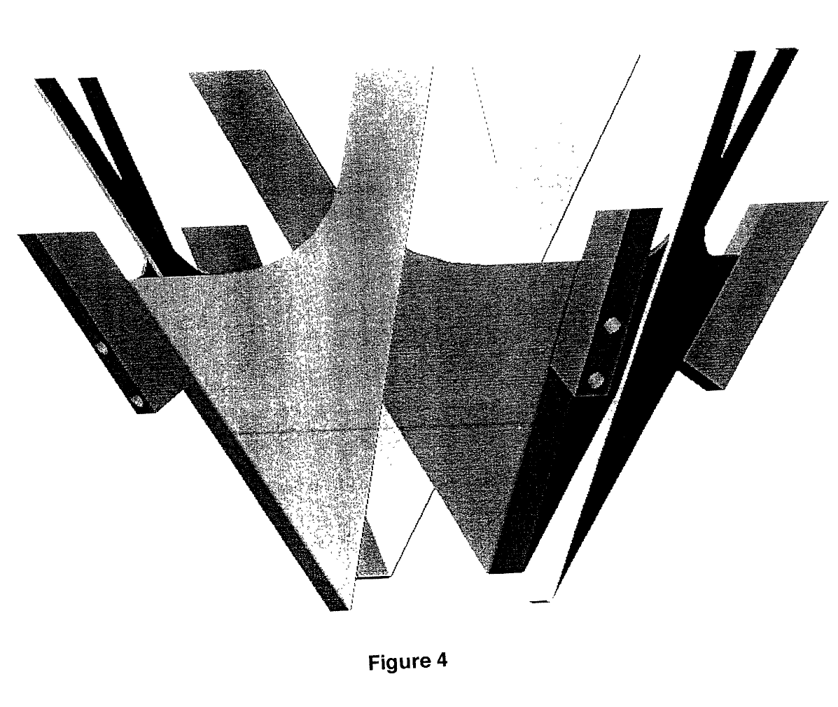

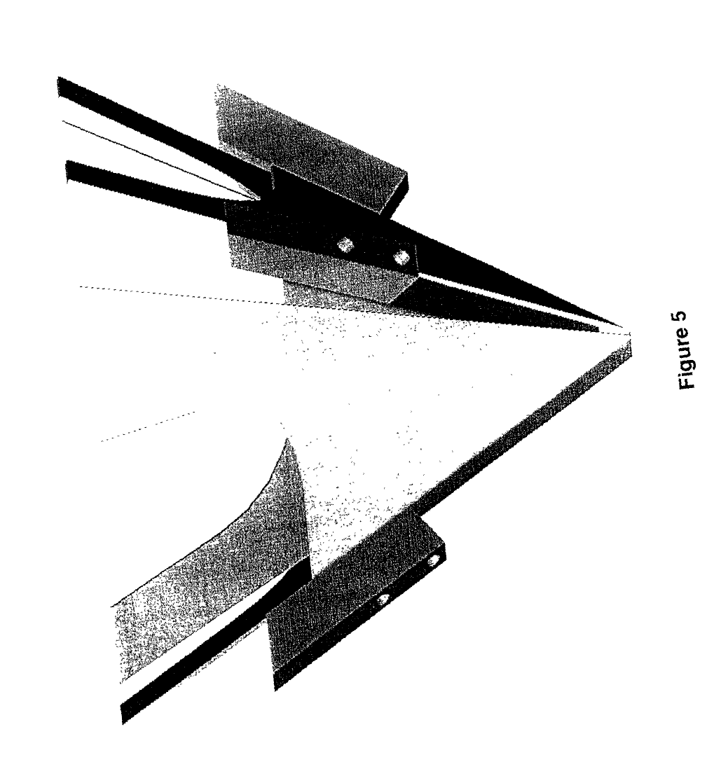

Referring to FIGS. 3 through 5, FIG. 3 shows the arrangement of the four blades in the self-sharpening embodiment, when the blades are in the retracted position. FIG. 4 shows that arrangement when the four blades in the halfway position. FIG. 5 shows that arrangement when the four blades in the cutting position.

### THE APPARATUS

One apparatus for the separation of fleurettes from long-stemmed vegetables having a flowery head has the cutting device describe above, and a conveyor means. The conveyor means includes vegetable supports for indexed advancing of vegetables, a loading station, and a cutting station. The conveyor means advances the vegetables from the loading station to the cutting station so that the center axis of the cutting device passes through the vegetables.

### THE METHOD

The vegetable is positioned on a surface under the cutting device so that the stalk is substantially upright relative to the surface on which it is placed. In other words, the head of the vegetable is resting on a surface and the stalk is sticking up. Preferably, the stalk should be substantially perpendicular to the surface, but it doesn't have to be, as long as the stalk is above the flowery head. There is a decrease in observed benefits as the angle of the stalk increasingly deviates from the perpendicular.

The surface upon which the vegetable is positioned can be flat or curved, stationary or moving, horizontal or inclined. For instance, in one preferred embodiment, the surface is a bowl on a horizontal conveyor belt. When the surface is curved, the term “relative to the surface upon which the vegetable rests” means “relative to” the plane that best represents the points of contact between the vegetable and that surface.

The vegetable is “positioned under the cutting device” either by moving the vegetable until it is under the cutting device, or by moving the cutting device until it is over the vegetable, or by moving both the cutting device and the vegetable. Preferably, the vegetable is in a bowl on a horizontal conveyor belt, which passes under the cutting device in its starting position, then the vegetable and the cutting device move in the same direction during the cutting operation.

After the vegetable is positioned under the cutting device, each blade of the cutting device is moved by the moving means downward toward the vegetable in a linear motion to sever the fleurettes from the vegetable

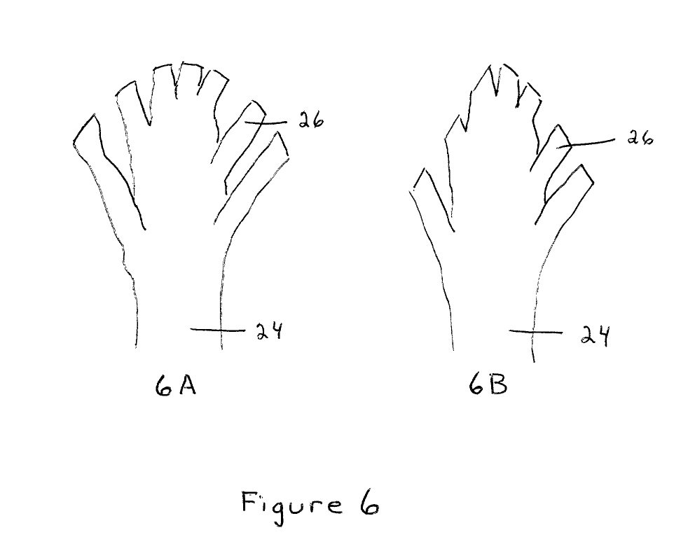

The primary advantage of the present invention is that less of the fleurette stems are left on the stalk, and more fleurette can be sold. A good stem is approximately half the weight of a fleurette. Since less of the fleurette stems are left on the stalk, the weight of produce that can be sold is increased. Fleurettes are sold by weight, so increasing the weight of the fleurettes increases the profits. Referring to FIG. 6, the left side of the drawing (A), shows a representation of a broccoli cut by a conventional round blade, and the right side of the drawing (B), shows a representation of a broccoli cut the present invention. Notice that the broccoli in FIG. 6B has less fleurette stem 26 still attached than the broccoli in FIG. 6A.

One of the surprising features of this invention is that the blades can be set to intersect the vegetable at a set height off the surface and that setting will be good for a wide variety of sizes for that vegetable. For instance, for broccoli the height is about 1 ⅜ to 1 ⅝ inches. The width of the broccoli head 22 may vary from three inches to six inches, but the distance from the top of the head 26 (FIG. 1) to the stalk 24 is always about 1 ⅜ to 1 ⅝ inches. If the blades of the present invention intersect the broccoli at that height, one produces a good cut on the stalk, with good fleurettes, no matter what the width of the head. With the prior art round blades (or curved cutting paths) the width of the head makes a big difference. Round blades could cut heads with widths of four to five inches, but would slice a three-inch head and would leave stem on a six-inch head.

While the present invention has been described with reference to specific embodiments, this application is intended to cover those various changes and substitutions that may be made by those skilled in the art without departing from the spirit and scope of the appended claims.

What is claimed is:

1. A cutting device for separating fleurettes from the stalk of a long-stemmed vegetable having a flowery head, said cutting device comprising:
(a) at least three blades, positioned symmetrically around a perpendicular center axis;
(1) wherein each blade has two flat surfaces joined at a linear backbone;
(2) wherein each flat surface has a cutting edge on its bottom;
(3) wherein each backbone forms an angle with the center axis of from 25 to 45 degrees; and
(b) moving means for moving each blade downward in a linear motion toward said center axis in the same angle with the center axis as formed by the blade backbone.

2. A cutting device according to claim 1 wherein each backbone forms an angle with the center axis of from 30 to 40 degrees.

3. A cutting device according to claim 2 wherein each backbone forms an angle with the center axis of about 35 degrees.

4. The cutting device of claim 1 wherein the stalk of a long-stemmed vegetable is substantially upright.

5. The cutting device of claim 4 wherein said stalk is cut at a set height of about 1 ⅜ to 1 ⅝ inches from the top of said flowery head.

6. The cutting device of claim 4 wherein said stalk is cut at a set height of about 1.5 inches from the top of said flowery head.

7. A cutting device according to claim 1 wherein said cutting device has four blades, and the two flat surfaces of each blade forms a perpendicular angle.

8. A cutting device according to claim 7 wherein two of the blades have inside cutting surfaces and two have outside cutting surfaces, and wherein the four blades are arranged symmetrically around the center axis so that the two blades having inside cutting surfaces are opposite each other and the two blades having outside cutting surfaces are opposite each other, and wherein the blades with the outside cutting surfaces are offset closer to each other, so that when the four blades move toward the center axis, each outside cutting surface contacts an inside cutting surface to self-sharpen the surfaces.

9. A cutting device according to claim 1 wherein said moving means is a cylindrical piston means.

10. A cutting device according to claim 9 wherein said cylindrical piston means comprises separate cylindrical pistons for each blade.

11. Apparatus for the separation of fleurettes from long-stemmed vegetables having a flowery head, the apparatus comprising:
(a) a cutting device according to claim 1; and
(b) conveyor means, said conveyor means including vegetable supports for indexed advancing of vegetables, a loading station and a cutting station, said conveyor means advancing said vegetables from said loading station to said cutting station so the center axis of the cutting device passes through said vegetables.

12. A method of separating fleurettes from the stalk of a long-stemmed vegetable having a flowery head, said method comprising:
(a) positioning the vegetable on a surface under a cutting device comprising:
(1) at least three blades, positioned symmetrically around a perpendicular center axis;
(i) wherein each blade has two flat surfaces joined at a linear backbone;
(ii) wherein each flat surface has a cutting edge on its bottom;
(ii) wherein each backbone forms an angle with the center axis of from 25 to 45 degrees; and
(2) moving means for moving each blade downward in a linear motion toward said center axis in the same angle with the center axis as formed by the blade backbone
wherein the perpendicular center axis of the cutting device passes through said vegetable and so that the stalk is substantially upright relative to the surface upon which the vegetable rests; and
(b) moving each blade of the cutting device downward toward the vegetable in a linear motion to sever the fleurettes from the vegetable.

13. A method according to claim 12 wherein said vegetable is positioned under the cutting device by moving said vegetable along a conveyor means.

14. A method according to claim 12 wherein all of said blades move in unison toward a common point about 1 ⅜ to 1 ⅝ inches from the surface upon which the vegetable rests.

15. A method according to claim 12 wherein all of said blades move in unison toward a common point about 1.5 inches from the surface upon which the vegetable rests.

16. A method of separating fleurettes from the stalk of a long-stemmed vegetable having a flowery head, said method comprising:
(a) positioning the vegetable on a surface so that the stalk is substantially upright relative to the surface upon which the vegetable rests;
(b) moving at least one blade downward toward the vegetable in a linear motion to sever the fleurettes from the vegetable, where said blade has at least one flat surface having a cutting edge, and wherein said blade severs said fleurettes at an angle of from 45 to 65 degrees from that surface.

17. The method of claim 16 wherein at least one blade cuts said stalk about 1.5 inches from the surface upon which the vegetable rests.
